(19) United States
(12) Patent Application Publication
(10) Pub. No.: US 2025/0002647 A1
(43) Pub. Date: Jan. 2, 2025

(54) POLYLACTIC ACID AND POLYETHER COMPOUNDS

(71) Applicant: Croda, Inc., Plainsboro, NJ (US)

(72) Inventors: Bingham Scott JAYNES, Plainsboro, NJ (US); Ruoran ZHANG, Plainsboro, NJ (US); Xin CHEN, Plainsboro, NJ (US)

(73) Assignee: Croda, Inc., Plainsboro, NJ (US)

(21) Appl. No.: 18/701,148

(22) PCT Filed: Oct. 10, 2022
(86) PCT No.: PCT/US2022/046163

§ 371 Date: Apr. 12, 2024

Related U.S. Application Data
(60) Provisional application No. 63/256,241, filed on Oct. 15, 2021.

(51) Int. Cl. C08G 65/26; C11D 1/00; D06M 15/53

(52) U.S. Cl. CPC C08G 65/2603; C11D 1/008; D06M 15/53; C08G 2650/64

(57) ABSTRACT

Compounds are described which are polylactic acid and polyether copolymers, wherein the compounds comprise: a) at least one of: a sorbitan ester residue, a C6 to C24 fatty alcohol residue or a C6 to C24 fatty acid residue; b) at least 2 lactic acid residues; and c) at least 2 oxyethylene groups; and wherein the compounds comprise at least two ether bonds and at least two ester bonds. A process for producing the compounds is also described, comprising reacting a) at least one of: a polysorbate, a C6 to C24 fatty alcohol ethoxylate or a C6 to C24 fatty acid ethoxylate; and b) lactide; wherein the compound comprises at least 2 lactic acid residues and at least 2 oxyethylene groups, and the use of such compounds as fibre finishes in non-woven materials such as personal hygiene products and/or as surfactants in cleaning applications such as home care formulations.

### CROSS-REFERENCE TO RELATED APPLICATIONS

This application claims priority to U.S. Provisional Patent Application No. 63/256,241, filed on Oct. 15, 2021 and entitled COMPOUNDS AND THEIR APPLICATION TO POLYMERIC SUBSTRATES, the entire disclosure of which is incorporated by reference herein.

### FIELD OF THE INVENTION

The present invention relates to polylactic acid and polyether compounds.

The invention further relates to the application of such compounds to polymeric substrates (or fibres) as fibre finishes and/or in home care or cleaning applications as surfactants, preferably as low-foaming and/or non-ionic surfactants.

The compounds of the invention may be applied as fibre finishes to nonwoven materials comprising polymeric substrates/fibres. Such polymeric substrates/fibres preferably include polyethylene (PE), polypropylene (PP) and polylactic acid (PLA). The invention further relates to the use of the compounds to treat polymeric substrates or polymeric fibres and to nonwoven materials and personal hygiene products comprising such treated polymeric substrates or polymeric fibres.

### BACKGROUND

Personal hygiene products of all sorts have been growing in popularity and type and consumers now have a large degree of choice in terms of cost and quality of personal hygiene products which are available on the market. Such products are used in direct contact with a person's skin, and often used in direct contact with delicate and sensitive skin areas or sensitive skin types.

The personal hygiene market is currently moving toward more sustainable and bio-based solutions for components of its products, such as nonwoven materials (including textiles) and fibre finishes. As part of this trend, manufacturers are starting to transition to materials that contain higher bio-based content and have better environmental profiles. This includes nonwoven materials made from substrates/fibres of polylactic acid (PLA), a bio-based compostable material or bio-based polyethylene (PE). Such polymeric substrates/fibres may require treatment with a fibre finish before they are suitable for use in a personal hygiene product.

Furthermore, there is a continual need for improved surfactants, such as surfactants which may be used in home care or cleaning applications. In certain applications, there may be a need for surfactants with lower foaming properties (low-foaming surfactants).

It is an object of the present invention to address at least one of the needs or disadvantages associated with the prior art.

### SUMMARY OF THE INVENTION

The present invention seeks to provide compounds which may be used in treating polymeric substrates (such as fibres) and/or in cleaning applications such as home care formulations. Preferably the compounds are useful in treating polymeric substrates to make them suitable for use in personal hygiene products. The compounds according to the invention may surprisingly provide one or more of the following benefits: shorter strike through times, lower run-off amounts, lower re-wet amounts, improved wettability, lower foaming properties, surfactancy properties.

Viewed from a first aspect, the present invention provides a compound which is a polylactic acid and polyether polymer (preferably copolymer), wherein the compound comprises:
a) at least one of: a sorbitan ester residue, a C6 to C24 fatty alcohol residue or a C6 to C24 fatty acid residue;
b) at least 2 lactic acid residues; and
c) at least 2 oxyethylene groups; and
wherein the compound comprises at least two ether bonds and at least two ester bonds.

Viewed from a second aspect, the invention provides a process for producing a compound wherein the process comprises the step of reacting the following reactants:
a) at least one of: a polysorbate, a C6 to C24 fatty alcohol ethoxylate or a C6 to C24 fatty acid ethoxylate; and
b) lactide;
   wherein the compound comprises at least 2 lactic acid residues at least 2 oxyethylene groups.

Viewed from a third aspect, the invention provides a compound obtainable by a process according to the second aspect.

Viewed from a fourth aspect, the invention provides the use of a compound of the first or third aspects to treat a polymeric substrate.

Viewed from a fifth aspect, the invention provides a method of treating a polymeric substrate by applying a compound according to the first or third aspects to the polymeric substrate.

Viewed from a sixth aspect, the invention provides a polymeric fibre, preferably comprising a polymeric substrate, wherein the polymeric fibre (and/or the polymeric substrate) has been treated with a compound according to the first or third aspects.

Viewed from a seventh aspect, the invention provides a nonwoven material treated with a compound of the first or third aspects.

Viewed from an eighth aspect, the invention provides a personal hygiene product comprising a nonwoven material of the seventh aspect.

Viewed from a ninth aspect, the invention provides a home care formulation comprising a compound according to the first or third aspects.

Viewed from a tenth aspect, the invention provides a cleaning formulation comprising a compound according to the first or third aspects.

Viewed from an eleventh aspect, the invention provides the use of a compound according to the first or third aspects as a surfactant, preferably a non-ionic surfactant.

Viewed from a twelfth aspect, the invention provides a method of reducing the foaming properties of a surfactant comprising the step of reacting at least two lactic acid residues onto the surfactant, preferably wherein the foaming of the surfactant is measured using ASTM D1173.

Any aspect of the invention may include any of the features described herein with regard to that aspect of the invention or any other aspects of the invention.

### DETAILED DESCRIPTION OF THE INVENTION

It will be understood that any upper or lower quantity or range limit used herein may be independently combined.

It will be understood that the term “wt %” refers to the percentage by weight of the specified component on the basis of the total weight of the specified entity which the component is a part of.

Many of the chemicals which may be used to produce the compounds of the present invention are obtained from natural sources. Such chemicals typically include a mixture of chemical species due to their natural origin. Due to the presence of such mixtures, various parameters defined herein can be an average value and may be non-integral.

The term “group” when used herein means a part of a molecule.

It will be understood that, when describing the number of carbon atoms in a substituent group (e.g., ‘C1 to C6’), the number refers to the total number of carbon atoms present in the substituent group, including any present in any branched groups. Additionally, when describing the total number of carbon atoms in, for example fatty acids, this refers to the total number of carbon atoms including the one at the carboxylic acid, and any present in any branch groups.

The term “residue” when used herein is the part of a reactant molecule which remains in the product compound after a reaction has occurred. For example, a sorbitan ester residue is the part of a sorbitan ester which remains in a compound after a chemical reaction with the sorbitan ester, for example ethoxylation, has occurred.

“Polysorbates” are a well-known family of products comprising ethoxylated sorbitan esters.

The term “personal hygiene product” includes a tissue, a wipe, a diaper, a pad, a feminine care product, or a face mask. A tissue may include facial or toilet tissues. A wipe may include baby wipes, toddler wipes, sterilization wipes, hand wipes (particularly antibacterial hand wipes), facial or body wipes (sometimes referred to as shower wipes). A diaper may include e.g. incontinence diapers for babies, adults, or children in the form of tab closure diapers, pull up pants (typical used for toddler potty training and young children with incontinence) or underwear (typically used for older children and adults with incontinence). Pads may include, e.g., breast feeding nursing pads, bed pads, incontinence pads for both children and adults, and sanitary pads. A feminine care product may include e.g. sanitary pads and tampons. Typically, personal hygiene products comprise at least a first and at least a second layer, however, wipes often preferably consist of a first layer only; this may preferably be the case where the wipes have been designed to be suitable for flushing as a means of disposal as minimizing the bulk of the overall product allows such products to be flushed with relative ease, and may also allow the products to break down more quickly once flushed to avoid undesirable blockages occurring in sanitation systems.

The term “nonwoven material” (including nonwoven fabrics or textiles) means a fabric-like material made from staple fibres (short) and/or long fibres (continuous long), bonded together by chemical, mechanical, heat or solvent treatment.

The term “fibre finish” means compounds/chemicals that are applied to fibers or fabrics/textiles as coatings, or compounds/chemicals that are impregnated into fabrics/textiles made of fibres, which are designed to enhance performance.

The term ‘home care formulation’ when used herein means a consumer product for use by household and/or institutional consumers for cleaning, caring, or conditioning of the home or its contents such as fabrics. Home care formulations include but are not limited to detergents including laundry detergents and dishwashing detergents; conditioners including fabric conditioners; cleaning formulations including hard surface cleaners; polishes and floor finishes.

The term ‘cleaning formulation’ when used herein includes home care formulations and industrial cleaning formulations such as vehicle, process or production equipment cleaning formulations.

The invention provides a compound which is a polylactic acid and polyether copolymer, wherein the compound comprises:
a) at least one of: a sorbitan ester residue, a C6 to C24 fatty alcohol residue or a C6 to C24 fatty acid residue;
b) at least 2 lactic acid residues; and
c) at least 2 oxyethylene groups; and
wherein the compound comprises at least two ether bonds and at least two ester bonds

The invention provides a process for producing a compound wherein the process comprises the step of reacting the following reactants:
a) at least one of: a polysorbate, a C6 to C24 fatty alcohol ethoxylate or a C6 to C24 fatty acid ethoxylate; and
b) lactide;
   wherein the compound comprises at least 2 lactic acid residues at least 2 oxyethylene groups.

Preferably a compound of the invention is obtainable by the process.

The term polylactic acid and polyether copolymer means that the compound is a copolymer which comprises at least two ether bonds (polyether) and at least two lactic acid residues (polylactic acid).

The compound of the invention may comprise at least 3 lactic acid residues, preferably at least 4. The compound may comprise at least 5 lactic acid residues, alternatively at least 6. The compound may comprise at most 30 lactic acid residues, preferably at most 26, more preferably at most 22, particularly at most 18. Preferably the compound comprises from 2 to 18 lactic acid residues, more preferably from 4 to 18 lactic acid residues.

The compound may comprise at least 3 oxyethylene groups, preferably at least 4. The compound may comprise at least 5 oxyethylene groups, alternatively at least 6. The compound may comprise at most 90 oxyethylene groups, preferably at most 60, more preferably at most 45, particularly at most 30. Preferably the compound comprises from 4 to 30 oxyethylene groups.

The compound may have a number average molecular weight (Mn) measured by gel permeation chromatography (GPC), preferably as described herein, of at least 500 Da, preferably at least 600 Da, more preferably at least 700 Da, particularly at least 800 Da. The compound may have a number average molecular weight (Mn) measured by gel permeation chromatography (GPC), preferably as described herein, of at most 10,000 Da, preferably at most 8000 Da, more preferably at most 6000 Da, particularly at most 4000 Da.

The compound may have a weight average molecular weight (Mw) measured by gel permeation chromatography (GPC), preferably as described herein, of at least 800 Da, preferably at least 900 Da, more preferably at least 1000 Da. The compound may have a weight average molecular weight (Mw) measured by gel permeation chromatography (GPC), preferably as described herein, of at most 12,000 Da, preferably at most 8000 Da, more preferably at most 6000 Da, particularly at most 4000 Da.

The compound may have a polydispersity index (PDI=Mw/Mn) from 1.01 to 1.8, preferably from 1.02 to 1.6, more preferably from 1.03 to 1.5.

A molecular weight or polydispersity index in these ranges may surprisingly provide one or more of the following benefits: shorter strike through times, lower run-off amounts, lower re-wet amounts, improved wettability.

Preferably the compound comprises a sorbitan ester residue. The sorbitan ester residue may be provided by a polysorbate. The sorbitan ester/poly sorbate may comprise a fatty acid. The fatty acid may be saturated or unsaturated. The fatty acid may be a C10 to C22 fatty acid, preferably a C12 to C18 fatty acid. Preferably the fatty acid is selected from lauric, palmitic, stearic and oleic fatty acids. The polysorbate may be ethoxylated. Preferably the polysorbate comprises from 2 to 30 oxyethylene groups, more preferably from 4 to 30 oxyethylene groups, even more preferably from 4 to 22 oxyethylene groups, particularly from 12 to 22 oxyethylene groups.

Preferably the compound comprises a C6 to C24 fatty alcohol residue. The C6 to C24 fatty alcohol residue may be provided by a C6 to C24 fatty alcohol ethoxylate. The C6 to C24 fatty alcohol may be saturated or unsaturated. The fatty alcohol may be a C10 to C22 fatty alcohol, preferably a C12 to C18 fatty alcohol. Preferably the fatty alcohol is selected from lauryl, cetyl, stearyl and oleyl fatty alcohols. The C6 to C24 fatty alcohol may be ethoxylated. Preferably the C6 to C24 fatty alcohol ethoxylate comprises from 2 to 30 oxyethylene groups, more preferably from 4 to 30 oxyethylene groups, even more preferably from 4 to 23 oxyethylene groups, particularly from 6 to 23 oxyethylene groups.

Preferably the compound comprises a C6 to C24 fatty acid residue. The C6 to C24 fatty acid residue may be provided by a C6 to C24 fatty acid ethoxylate. The C6 to C24 fatty acid may be saturated or unsaturated. The fatty acid may be a C10 to C22 fatty acid, preferably a C12 to C18 fatty acid. Preferably the fatty acid is selected from lauric, palmitic, stearic and oleic fatty acids. The C6 to C24 fatty acid may be ethoxylated. Preferably the C6 to C24 fatty acid ethoxylate comprises from 2 to 30 oxyethylene groups, more preferably from 4 to 30 oxyethylene groups, even more preferably from 4 to 25 oxyethylene groups, particularly from 6 to 25 oxyethylene groups.

Preferably the oxyethylene groups in the compound are derived from ethylene oxide. According to one embodiment, the oxyethylene groups in the compound are derived from at least one ethylene oxide monomer containing a ¹⁴C/¹²C ratio at a level corresponding to a bio-based material, according to the standard ASTM D6866. For example, the ethylene oxide may be synthesized from ethylene which is itself synthesized from ethanol from a biological source (bioethanol). Preferably the ethylene oxide is synthesized from bioethanol. Bioethanol may be derived from the fermentation of renewable raw materials, in particular vegetable raw materials selected from sugar cane, sugar beet, maple, date palm, sugar palm, sorghum, agave, corn, wheat, barley, sorghum, soft wheat, rice, potato, cassava, sweet potato and algae. Preferably the bioethanol is derived from corn.

Preferably, the oxyethylene groups in the compound have a renewable carbon content of at least 50 wt %, more preferably at least 75 wt %, particularly at least 90 wt %, desirably of about 100 wt %, based on the total weight of oxyethylene groups in the compound, when determined using ASTM D6866.

Lactide is a dimer which comprises at least two, preferably two lactic acid residues. Preferably the lactic acid residues in the compound are derived from lactide. The lactide may be available from known commercial sources. A lactide dimer has two centers of chirality. As a result, it is available in its chiral forms (either L or D) or in a “meso” form (where both stereocenters point the same way and the overall molecule is non-chiral). The lactide used may be meso, L or D form, preferably meso or L form.

The compound of the invention, when added to a PLA substrate as described herein, may provide a strike-through time measured according to ISO 9073-13:2001 (as described herein) of less than 5 s, preferably less than 4 s, more preferably less than 3 s, particularly less than 2 s. The compound of the invention may provide a strike-through time measured according to ISO 9073-13:2001 of at least 0.5 s.

The compound of the invention, when added to a PLA substrate as described herein, may provide a run-off measured according to ISO 9073-11:2001 (as described herein) of less than 2 g, preferably less than 1.5 g, more preferably less than 1 g, particularly less than 0.5 g. Preferably the compound of the invention, when added to a PLA substrate as described herein, provides no run-off (0 g) when measured according to ISO 9073-11:2001.

The compound of the invention, when added to a PLA substrate as described herein, may provide a re-wet measured according to NWSP 70.9 (as described herein) of less than 2 g, preferably less than 1.5 g, more preferably less than 1 g, particularly less than 0.5 g. The compound of the invention, when added to a PLA substrate as described herein, may provide a re-wet measured according to NWSP 70.9 of at least 0.05 g.

The invention further provides the use of a compound according to the invention to treat a polymeric substrate. Preferably the polymeric substrate is a polymeric fibre or material, more preferably a non-woven material.

Preferably the invention provides the use of a compound according to the invention to treat a polymeric substrate by applying the compound to the substrate to produce a treated polymeric substrate. Preferably the treated polymeric substrate is less hydrophobic than the polymeric substrate. Preferably the treated polymeric substrate being less hydrophobic is indicated by a shorter strike-through time, measured as described herein. Alternatively, the treated polymeric substrate may be more hydrophobic than the polymeric substrate.

The invention further provides a method of treating a polymeric substrate as described herein by applying a compound according to the invention to the polymeric substrate. Preferably the method produces a treated polymeric substrate which is less hydrophobic than the polymeric substrate. Alternatively, the treated polymeric substrate may be more hydrophobic than the polymeric substrate.

The polymeric substrate may be a hydrophobic substrate. The polymeric substrate may be selected from polyolefins, polyesters, polycarbonates, polyamides, cellulose (e.g. cotton, wood pulp), keratin (e.g. wool) and copolymers or mixtures thereof. Preferably the polymeric substrate is selected from polyolefins and polyesters. Preferably the polymeric substrate comprises, as a polymer or co-polymer, at least one of polylactic acid, polyethylene and polypropylene. The polylactic acid may comprise poly-L-lactic acid (PLLA). The polylactic acid may comprise poly-D-lactic acid (PDLA). The polylactic acid may comprise a mix of chiral forms.

A polymeric fibre may comprise the polymeric substrate. The invention further provides a polymeric fibre, preferably comprising the polymeric substrate, wherein the polymeric fibre has been treated with a compound of the invention. The polymeric fibre and/or the polymeric substrate may be treated with a compound of the invention.

The invention further provides a nonwoven material, preferably comprising the polymeric fibre, wherein the nonwoven material has been treated with a compound of the invention. The treatment of the nonwoven material may be by treatment of the polymeric fibre and/or the polymeric substrate.

The invention further provides a personal hygiene product comprising a nonwoven material or a polymeric fibre, wherein the nonwoven material or the polymeric fibre has been treated with a compound according to the invention. The personal hygiene product may be a tissue, a wipe, a diaper, a pad, a feminine care product, or a face mask. The personal hygiene product may comprise at least a first and a second layer.

Preferably the compounds of the invention are suitable for use in home care formulations or cleaning formulations. The present invention may provide a home care formulation comprising a compound of the invention. The home care formulation may be selected from fabric detergents (in liquid, powder, concentrated, unit dose or tablet form), fabric conditioners or softeners (in liquid, powder, concentrated, unit dose or tablet form), fabric wash additives, fabric scent boosters (in liquid, gel, tablet, powder or granule form), refresher sprays, air care products, cleaning products, fabric cleaners, stain removers, hard surface cleaners, hand dishwashing detergents, machine dishwashing detergents, polishes and floor finishes. Preferably the home care formulation is selected from hard surface cleaners (such as floor cleaners & glass cleaners), fabric detergents & machine dishwashing detergents. The cleaning formulation may be a home care formulation or an industrial cleaning formulation, preferably a clean-in-place formulation.

The home care formulation, preferably hard surface cleaner, may comprise a compound according to the invention and at least one additional home care ingredient. The additional home care ingredient may be selected from detergents, surfactants, ironing aides, drying additives, builders, chelating agents or chelators, dye transfer inhibiting agents, dispersants, enzymes, enzyme stabilizers, catalytic materials, bleaches, bleach activators, hydrogen peroxide, sources of hydrogen peroxide, preformed peracids, polymeric dispersing agents, soil removal/anti-redeposition agents, brighteners, suds suppressors, dyes, fabric softening compounds, carriers, structurants, hydrotropes, processing aids, solvents and/or pigments and mixtures thereof. Preferably the additional home care ingredient is selected from the group consisting of surfactants, builders, chelating agents and solvents.

The home care formulation may comprise from 0.01 to 10 wt % of the compound of the invention, on the basis of the total weight of the formulation. Preferably the home care formulation comprises at least 0.02 wt %, more preferably at least 0.05 wt %, more preferably at least 0.1 wt %, more preferably at least 0.2 wt % of the compound of the invention, on the basis of the total weight of the formulation. Preferably the home care formulation comprises at most 20 wt %, more preferably at most 15 wt %, more preferably at most 10 wt %, more preferably at most 5 wt % of the compound of the invention, on the basis of the total weight of the formulation.

The invention further provides the use of a compound of the invention as a surfactant, preferably a non-ionic surfactant. Preferably the compound is used in a cleaning formulation, more preferably a low-foaming cleaning formulation. The foaming of the formulation may be measured using ASTM D1173 (Ross-Miles foam test) as described herein.

The invention further provides a method of reducing the foaming properties (or foaming) of a surfactant comprising the step of reacting at least two lactic acid residues onto the surfactant, preferably wherein the foaming properties of the surfactant is measured using ASTM D1173. Preferably the surfactant is selected from a polysorbate, a C6 to C24 fatty alcohol ethoxylate or a C6 to C24 fatty acid ethoxylate.

The foaming properties (foaming) of the surfactant, measured according to ASTM D1173 (preferably at 5 minutes) may be reduced by at least 10%, preferably at least 15%, more preferably at least 20%, yet more preferably at least 25%, even more preferably at least 30%. The foaming properties (foaming) of the surfactant, measured according to ASTM D1173 (preferably at 5 minutes) may be reduced by at most 99%, preferably at most 95%, more preferably at most 90%.

Any or all of the features described herein, and/or any or all of the steps of any method or process described herein, may be used in any combination in any aspect of the invention.

### EXAMPLES

The invention is illustrated by the following non-limiting examples. It will be understood that all tests and physical parameters described herein have been determined at atmospheric pressure and room temperature (i.e. about 20° C.), unless otherwise stated herein, or unless otherwise stated in the referenced test methods and procedures. All parts and percentages are given by weight unless otherwise stated.

### Test Methods

In this specification, the following test methods are used:

### (i) GPC

For the Gel Permeation Chromatography results described herein, the following apparatus and settings were used:
Pump: Agilent 1260
Flow: 1 mL/min
Injector: Agilent 1260
Injection Vol.: 20 μL
Column oven: Agilent 1260
Temperature: 40° C.
Columns: PLgel 5 μm 100 Å, PLgel 5 μm 100 Å; Length: 30 cm, i.d: 7.5 mm
Particle size: 5 μm
Detector: Agilent 1260 Refractive Index Detector (RID)
Temperature: 40° C.
Mobile phase: Tetrahydrofuran, stabilized
Run time: 20 min

The molecular weight averages (Mw and Mn) and polydispersity were calculated against polystyrene standards (PS) using a 3rd order polynomial fit.

### (ii) Strike-Through

Strike-through measures how quickly a liquid passes through a nonwoven fabric sample. The liquid used as a standard substitute for urine is 9 gL⁻¹ NaCl solution, which is dropped into a well above a layer of the nonwoven sample and absorbent filter papers. A timer measures how long it takes for the solution to soak through the nonwoven. Strike-through is measured by a Lenzing Instruments Lister-AC apparatus in seconds—a shorter time meaning a faster penetration through the nonwoven sample which is desirable. The Lister instrument measures the strikethrough time according to ISO reference 9073-8:1995 and ISO reference 9073-13:2001.

(iii) Run-Off

Run-off is another way to assess speed of absorption and durability of the finish, which measures the amount of excess liquid that runs from the test specimen—a lower amount being desirable. It is a comparative test method and not designed to simulate real use conditions. NaCl solution (9 gL⁻¹, 20 mL) is poured onto a nonwoven sample. The solution should be absorbed quickly into the treated nonwoven, so no liquid runs off the edge. Any lost liquid is caught by a sponge and weighed. Run-off is quoted as total g or % of liquid applied. Run-off is measured with a Run-Off Tester (Testex TN130) which measures the run-off weight according to ISO reference 9073-11:2001.

### (iv) Re-Wet

Re-wet measures the amount of wetness returned from the surface of a nonwoven sample onto an absorbent filter paper—a lower amount being desirable. The initial strikethrough time is first measured and recorded as described above. Wait ten minutes and weigh a stack of dry filter paper (W1) and place them in the centre of wetted target area. Place a cylindrical weight on top of dry filter paper for 1 minute. Reweigh the filter paper stack (W2) so Rewet (g)=W2-W1. This test is according to the NWSP 70.9 standard method.

### (v) Wettability

The wettability test measures the time it takes for a fiber finish to be absorbed through an untreated non-woven sheet with an absorbent backing under the test sheet. Dispense ten drops of prepared fiber finish solution one by one on the nonwoven sheet and measure the time (in seconds) of each drop to be absorbed through the sheet. A shorter average time of the ten drops corresponds to a faster wetting speed of fiber finish on nonwoven sample.

### (vi) ASTM D1173—Standard Test Method for Foaming Properties of Surface-Active Agents (Ross-Miles Foam Test)

This static foam test measures the foam generated for a surfactant solution of known concentration, 0.1% active, under standard conditions as described below. 50 ml of test solution is first added to the main reservoir. To the 50 ml in the main reservoir is then added 200 ml of test solution dispensed from a pipette positioned above approximately 90 cm above the main reservoir. As the 200 ml of test solution drops onto the 50 ml in the main reservoir, foam is generated upon impact of the two liquids. Upon complete addition of the 200 ml, the foam height is measured visually in mm by an attached ruler in the side of the reservoir. Foam height is measured initially, then at 30 seconds, 1 min., 3 min., and 5 min. An automated instrument, the Kruss RMFA, was also run in a similar manner, except that optical sensors on the side of the reservoir are used to measure foam heights.

(vii) SITA R-2000 Dynamic Foam Test

This is a dynamic foam test that uses the SITA R-2000 foam tester to measure the foaming properties of surfactant solutions. Solutions are tested at 0.1% active concentration. 250 ml of test solution is added to a glass vessel equipped with a rotating mechanical stirrer. The solution is subject to 10 second of stirring for 15 cycles. The foam height is measured electronically by needle sensors after each stirring cycle, producing a plot of foam generation over the 15 cycles. After the 15 cycles, the foam heights are measured every 30 seconds for 10 minutes without any additional stirring by the sensor. These values indicate the foam decay for the sample. Both foam build and foam decay are displayed and plotted by the instrument.

(viii) ASTM D2281—Standard Test Method for Evaluation of Wetting Agents by the Skein Test (Draves Wetting Test)

This test measures how fast a surfactant solution can wet out a cotton fabric skein. A weighted cotton test skein is dropped into a tall glass cylinder containing a wetting agent of known concentration dissolved in water. The time required for the cotton skein to become wet and sink, relaxing the string stirrup to which it is attached, will be recorded as the sinking time. This time relates to the speed at which the wetting agent penetrates the skein and can be used to compare the wetting speed of different surfactants. Typical fast wetting agents wet in <30 seconds.

### (ix) Surface Tension Measurement

This measurement of surface tension uses the Wilhelmy Plate Method on a Kruss K100 tensiometer instrument. The force resulting from the wetting of a vertically suspended plate submerged into the test solution is measured and used to calculate surface tension expressed in units of mN/m. This is a universal method to measure the surface tension of a surfactant solution and is typically carried out at a concentration of 0.1% active.

### Example 1

Samples for testing were synthesized using the following method:
1) Clean, safety-test and dry a reactor before use.
2) Charge Brij, Tween or Myrj (all available ex Croda) raw material into the reactor equipped with a heating mantle, nitrogen purge, magnetic stirring and thermocouple.
3) With agitation and nitrogen sweep on, charge Lactide raw material and Stannous Octoate catalyst (0.3 wt %) into the reactor and heat the reactor to 160° C. An exotherm is observed, make sure the temperature will not exceed 180° C.

4) Hold the reaction at 160° C. for 6 h.

5) After 6 h, cool down the reaction mixture to 80° C. and filter the product with filter aid.

Table 1 shows samples according to the invention which were synthesised using this method, with each mole of lactide providing 2 lactic acid (LA) residues since lactide is a cyclic di-ester comprising 2 lactic acid residues.

The EO number associated with the materials in Table 1 is the average number of oxyethylene groups in the material. For example Brij L7 is a lauryl alcohol ethoxylate (7EO) which comprises 7 oxyethylene groups, equivalent to ethoxylation with 7 mols of ethylene oxide.

TABLE 1
Samples synthesized

| | | Mole | Weight | Wt |
|---|---|---|---|---|
| Sample | Raw materials | ratio | (g) | % |
| (LA)2-Brij | Lactide | 1.00 | 69.3 | 23.11 |
| L6 | Brij L6 | 1.00 | 230.7 | 76.89 |
| | (Lauryl alcohol | | | |
| | ethoxylate-6EO) | | | |
| (LA)2-Brij | Lactide | 1.00 | 67.7 | 22.56 |
| L7 | Brij L7 | 1.00 | 232.3 | 77.44 |
| | (Lauryl alcohol | | | |
| | ethoxylate-7EO) | | | |
| (LA)2-Brij | Lactide | 1.00 | 59.5 | 19.83 |
| L9 | Brij L9 | 1.00 | 240.5 | 80.17 |
| | (Lauryl alcohol | | | |
| | ethoxylate-9EO) | | | |
| (LA)4-Brij | Lactide | 2.00 | 110.4 | 36.82 |
| L7 | Brij L7 | 1.00 | 189.6 | 63.18 |
| | (Lauryl alcohol | | | |
| | ethoxylate-7EO) | | | |
| (LA)6-Brij | Lactide | 3.00 | 127.8 | 42.59 |
| L9 | Brij L9 | 1.00 | 172.2 | 57.41 |
| | (Lauryl alcohol | | | |
| | ethoxylate-9EO) | | | |
| (LA)8-Brij | Lactide | 4.00 | 149.2 | 49.73 |
| L9 | Brij L9 | 1.00 | 150.8 | 50.27 |
| (LA)10-Brij | Lactide | 5.00 | 149.1 | 49.70 |
| L12 | Brij L12 | 1.00 | 150.9 | 50.30 |
| | (Lauryl alcohol | | | |
| | ethoxylate-12EO) | | | |
| (LA) 16-Brij | Lactide | 8.00 | 135.6 | 45.20 |
| L23 | Brij L23 | 1.00 | 164.4 | 54.80 |
| | (Lauryl alcohol | | | |
| | ethoxylate-23EO) | | | |
| (LA)14-Brij | Lactide | 7.00 | 139.9 | 46.64 |
| C20 | Brij C20 | 1.00 | 160.1 | 53.36 |
| | (Cetyl alcohol | | | |
| | ethoxylate-20EO) | | | |
| (LA) 14-Brij | Lactide | 7.00 | 152.0 | 50.65 |
| O20 | Brij 020 | 1.00 | 148.0 | 49.35 |
| | (Oleyl alcohol | | | |
| | ethoxylate-23EO) | | | |
| (LA) 4- | Lactide | 2.00 | 57.0 | 19.02 |
| Tween 20 | ECO Tween 20* | 1.00 | 243.0 | 80.98 |
| | (Polysorbate 20) | | | |
| (LA)8-Tween | Lactide | 4.00 | 95.9 | 31.96 |
| 20 | ECO Tween 20* | 1.00 | 204.1 | 68.04 |
| | (Polysorbate 20) | | | |
| (LA)14- | Lactide | 7.00 | 135.3 | 45.11 |
| Tween 20 | ECO Tween 20* | 1.00 | 164.7 | 54.89 |
| | (Polysorbate 20) | | | |
| (LA)14- | Lactide | 7.00 | 130.5 | 43.51 |
| Tween 80 | Tween 80 | 1.00 | 169.5 | 56.49 |
| | (Polysorbate 80) | | | |
| (LA)6-Myrj | Lactide | 3.00 | 126.9 | 42.32 |
| S8 | Myrj S8 | 1.00 | 173.1 | 57.68 |
| | (Stearic acid | | | |
| | ethoxylate-8EO) | | | |

*ECO denotes made with ethylene oxide from a renewable (non-petrochemical) source

Samples from Table 1 were then used to treat Polypropylene (PP) and Polylactic acid (PLA) polymeric substrates. These substrates are often used as fibres in nonwoven materials which are typically used in personal hygiene products. The PP and PLA are treated with a Sample from Table 1 as a fiber finish at a certain % add-on level using a Testex TD110 Motorized Lab Wringer supplied by Testex Textile. First a certain concentration of fiber finish solution/emulsion was prepared in water and slowly poured over the stack of nonwoven sheets until the stack was fully immersed in a container.

The surfactant solution was gently worked into the fibers of the nonwoven sheets until a change in the color of the nonwoven sheets was observed. When the sheets were completely wet and saturated with solution, the sheets were lifted from the container allowing excess solution to drain from the sheets and the stack was folded in half for easier handling. The stack was carefully passed through the rollers of the wringer to remove excess liquid until the desired weight was reached (2× initial weight). The % add-on is the weight percent of the Sample on the treated fabric. It is calculated as:

$$\% Add - on = \frac{{W}_{d} - {W}_{o}}{{W}_{o}} \times \% 100$$

Where: % W_{d}=dry weight of nonwoven sheet after treatment (after drying in the oven)

% Wₒ=original weight of nonwoven sheet (after drying in the oven)

### Example 2

Selected samples from Example 1 were analysed using GPC as described in the Test Methods above to measure their number average molecular weight (Mn) and weight average molecular weight (Mw). The polydispersity index (PDI) was calculated as Mw/Mn. The results are given in Table 2.

TABLE 2
GPC measurements

| | Mn | Mw | |
|---|---|---|---|
| Sample | (Da) | (Da) | PDI |
| (LA)6-Brij L9 | 903 | 1112 | 1.23 |
| (LA)8-Brij L9 | 922 | 1217 | 1.32 |
| (LA)10-Brij L12 | 1881 | 2168 | 1.15 |
| (LA)16-Brij L23 | 2926 | 3171 | 1.08 |
| (LA)14-Brij C20 | 2455 | 2700 | 1.10 |
| (LA)14-Brij O20 | 2351 | 2593 | 1.10 |
| (LA)14-Tween 20 | 2376 | 2777 | 1.17 |
| (LA)14-Tween 80 | 3115 | 3451 | 1.11 |

### Example 3

Selected samples from Example 1 were applied to PLA & PP substrates as described in Example 1 and tested for Strike-through as described in the Test Methods above. The following Comparative Samples (not of the invention) of commercially available fibre finishes were also tested:
a. Stantex S6757 (available ex Pulcra Chemicals)
b. Lurol (available ex Goulston)

Multiple tests were conducted and an average Strike-through time over the tests was calculated. 3 strike-through tests are run over the same spot of the fabric. The 1^{st} test shows the initial performance while the 3^{rd} test shows the performance after 3 repeats. A 3^{rd} test value that is higher than the 1^{st} test value shows that the performance of the sample is degrading over time. The results are given in Table 3.

TABLE 3
Strike-through measurements

| | % | Polymeric | 1^{st} Strike- | 3^{rd} Strike- | Average |
|---|---|---|---|---|---|
| | Add- | Substrate/ | through | through | Strike- |
| Sample | on | Fibre | (s) | (s) | through (s) |
| (LA)6-Brij | 0.2 | PP | 2.09 | 2.09 | 2.03 |
| L9 | | PLA | 1.62 | 1.86 | 1.85 |
| | 0.6 | PP | 1.88 | 2.03 | 2.13 |
| | | PLA | 1.77 | 1.87 | 1.94 |
| (LA)8-Brij | 0.2 | PP | 2.12 | 2.04 | 2.09 |
| L9 | | PLA | 1.70 | 1.98 | 1.91 |
| (LA)10- | 0.2 | PP | 2.10 | 2.11 | 2.22 |
| Brij L12 | | PLA | 1.80 | 1.97 | 1.81 |
| (LA)14- | 0.6 | PP | 2.00 | 1.94 | 2.00 |
| Tween 20 | | PLA | 1.34 | 1.40 | 1.40 |
| (LA)6-Myrj | 0.6 | PP | 2.04 | 1.99 | 1.98 |
| S8 | | PLA | 1.77 | 1.77 | 1.65 |
| Lurol | 0.2 | PP | 11.14 | 23.55 | 17.83 |
| | | PLA | 2.6 | 2.78 | 2.85 |
| | 0.6 | PP | 11.45 | 15.33 | 13.32 |
| | | PLA | 2.28 | 2.79 | 2.50 |
| Stantex | 0.2 | PP | 2.23 | 8.42 | 8.68 |
| S6757 | | PLA | 1.70 | 2.75 | 2.46 |
| | 0.6 | PP | 2.05 | 9.4 | 5.06 |
| | | PLA | 1.78 | 1.86 | 2.04 |

It can be seen from Table 3 that the Samples of the Invention had shorter (improved) strike-though times on average when compared with the Comparative Samples. In addition, there was less variation between the 1^{st} & 3^{rd} test results for the Samples of the Invention showing that these were more durable and degraded less over repeated tests.

### Example 4

Selected samples from Example 1 were applied to PLA & PP substrates as described in Example 1 and tested for Run-off as described in the Test Methods above. Multiple trials were conducted and an average Run-off value over the trials was calculated. The results are given in Table 4.

TABLE 4
Run-off measurements

| | % | Polymeric | Average |
|---|---|---|---|
| Sample | Add-on | Substrate/Fibre | Run-off (g) |
| (LA)4-Brij L7 | 0.6 | PLA | 0 |
| (LA)6-Brij L9 | 0.6 | PLA | 0 |
| (LA)6-Brij L9 | 0.2 | PLA | 0 |
| (LA)6-Brij L9 | 0.1 | PLA | 0 |
| (LA)6-Brij L9 | 0.2 | PP | 0.44 |
| (LA)10-Brij L12 | 0.2 | PLA | 0 |
| (LA)10-Brij L12 | 0.2 | PP | 1.84 |
| (LA)16-Brij L23 | 0.2 | PLA | 0 |
| (LA)16-Brij L23 | 0.2 | PP | 6.13 |
| (LA)6-Myrj S8 | 0.6 | PP | 0.24 |
| (LA)6-Myrj S8 | 0.6 | PLA | 0 |

It can be seen from Table 4 that most combinations of Sample and substrate have no measurable run-off which is a good indicator of high performance as a fibre finish.

### Example 5

Selected samples from Example 1 were applied to PLA & PP substrates as described in Example 1 and tested for Rewet as described in the Test Methods above. The results are given in Table 5.

TABLE 5
Re-wet measurements

| | % | Polymeric | Average |
|---|---|---|---|
| Sample | Add-on | Substrate/Fibre | Re-wet (g) |
| (LA)6- | 0.2 | PLA | 0.15 |
| Brij L9 | | PP | 0.19 |
| (LA)14- | 0.2 | PLA | 0.13 |
| Tween 20 | | PP | 0.20 |

It can be seen from Table 5 that the Samples of the Invention met a target re-wet weight of less than 0.2 g. The target of less than 0.2 g re-wet is generally used in the technical area of high-performance fibre finishes.

### Example 6

Selected samples from Example 1 were used to perform the wettability test on PLA & PP substrates as described in the Test Methods above. The results are given in Table 6.

TABLE 6
Wettability measurements

| | | Polymeric | Average Emulsion |
|---|---|---|---|
| | % | Substrate/ | Drop Absorption |
| Sample | Add-on | Fibre | Time (s) |
| (LA)6-Brij | 0.6 | PLA | 1 |
| L9 | | PP | 5 |
| Cirrasol | 0.6 | PLA | 17 |
| Care | | PP | 36 |
| Cirrasol | 0.6 | PLA | 21 |
| PP842 | | PP | 93 |
| Stantex | 0.6 | PLA | 1 |
| S6757 | | PP | 4 |

It can be seen from Table 6 that the Sample of the Invention has a significant shorter absorption time (faster wetting rate) than current Croda's commercial fibre finishes (Cirrasol Care or PP842). As a water-dispersible finish, (LA)6-Brij L9 had comparable wettability with the competitor's finish Stantex S6757 (note that this is a water-soluble finish which is expected to have better wettability than water-dispersible ones). However, as can be seen from Table 3 the Stantex S6757 performs worse after multiple strike-though tests indicating it is not as durable as the compounds of the invention.

### Example 7

Selected samples from Example 1 were evaluated for foaming properties using both the Ross-Miles and SITA foam methods as described in the Test Methods above. All materials were tested in solution in water at a concentration of 0.1% by weight. As shown in Table 7A, a series of lactide modified alcohol ethoxylates with two moles of lactic acid (LA) were compared to their corresponding alcohol ethoxylates without lactide modification. By comparing the foaming properties of the two sets of materials, it was observed that addition of two moles of lactic acid to the corresponding alcohol ethoxylate resulted in a significant reduction in foaming compared to the alcohol ethoxylate alone. This foam reduction was observed using both static and dynamic foam measurement methods, and was observed immediately after agitation (T=0) and after allowing time for foam decay.

TABLE 7A
Ross-Miles and SITA Foaming Measurements for Alcohol
Ethoxylates and Corresponding Lactide Derivatives

| | | | Ross Miles Foam Test | | | | |
|---|---|---|---|---|---|---|---|
| | SITA Foaming (ml) | | (Height in mm) | | | | |
| | | t = 5 | 0 | 30 | 1 | 3 | 5 |
| Active @ 0.1% | t = 0 | min. | sec | sec | min | min | min |
| Brij L6 (laureth-6) | 378 | 167 | 115 | 103.5 | 98 | 92 | 86 |
| (LA)2-Brij L6 | 191 | 83 | 81 | 74 | 72 | 63 | 57 |
| Brij L7 (laureth-7) | 381 | 132 | 100 | 100 | 100 | 100 | 100 |
| (LA)2-Brij L7 | 253 | 102 | 70 | 65 | 55 | 35 | 25 |
| Brij L9 (laureth-9) | 398 | 134 | 110 | 105 | 105 | 105 | 100 |
| (LA)2-Brij L9 | 307 | 136 | 95 | 85 | 80 | 50 | 30 |

In a similar manner to the data presented in Table 7A, the same foam measurements were made on lactide modified polysorbate 20, specifically ECO Tween 20 from Croda. As shown in Table 7B, lactide derivatives of Tween 20 with both four and eight moles of lactic acid (LA) were tested for foaming using the two different foaming methods and results were compared to those for Tween 20 alone. As in the case of the lactide modified alcohol ethoxylates in Table 7A, the lactide modified Tween 20 shown in Table 7B exhibited significantly lower foam generation under static and dynamic conditions. This was true both initially and after allowing time for foam decay.

TABLE 7B
Ross-Miles and SITA Foaming Measurements for Polysorbate
(Tween 20) and Corresponding Lactide Derivatives

| | | | Ross Miles Foam Test | | | | |
|---|---|---|---|---|---|---|---|
| | SITA Foaming (ml) | | (Height in mm) | | | | |
| | | t = 5 | 0 | 30 | 1 | 3 | 5 |
| Active @ 0.1% | t = 0 | min. | sec | sec | min | min | min |
| ECO Tween 20 | 368 | 290 | 85 | 80 | 80 | 80 | 75 |
| (polysorbate-20) | | | | | | | |
| (LA)₈-Tween 20 | 140 | 104 | 20 | 20 | 15 | 15 | 15 |
| (LA)₄-Tween 20 | 251 | 134 | 40 | 40 | 40 | 40 | 35 |

These low foaming properties observed in the lactide modified alcohol ethoxylates and polysorbate 20 are highly beneficial in cleaning applications such as hard surface (window or floor) or industrial cleaning formulations, where foaming is not desirable.

### Example 8

The same materials that were evaluated for foaming in Example 7 were also evaluated for speed of solubility, surface tension and Draves wetting time as described in the Test Methods above. These properties are key aspects of effective surfactants and indicate the potential effectiveness of the claimed materials. All materials were tested in solutions of water at a concentration of 0.1% by weight. As shown in Table 8A, a series of lactide modified alcohol ethoxylates with two moles of lactic acid (LA) were compared to their corresponding alcohol ethoxylates without lactide modification. By comparing the corresponding sets of data, it was observed that the addition of two moles of lactic acid to the corresponding alcohol ethoxylate did not significantly affect the surface tension or wetting speed of the surfactants. Interestingly, it was also observed that the LA modified materials were significantly faster to dissolve in water than the un-modified materials. This higher rate of solubility indicates that gel formation is reduced for the LA-modified materials offering a processing benefit over the unmodified Brij materials that can be slow to dissolve in water due to gel formation.

TABLE 8A
Physical properties of Alcohol Ethoxylates
and Corresponding Lactide Derivatives

| | | Draves | Surface | Water solubility |
|---|---|---|---|---|
| | | Wetting | Tension | (Fast: < 30 sec, |
| Active @ 0.1% | pH | (sec) | (mN/m) | Slow: >30 sec) |
| Brij L6 (laureth-6) | 5.7 | 14 | 28.6 | Slow |
| (LA)2-Brij L6 | 4.3 | 16 | 30.8 | Fast |
| Brij L7 (laureth-7) | 5.0 | 10 | 28.4 | Slow |
| (LA)2-Brij L7 | 4.6 | 14 | 31.3 | Fast |
| Brij L9 (laureth-9) | 5.8 | 18 | 32.1 | Slow |
| (LA)2-Brij L9 | 4.3 | 10 | 32.4 | Fast |

In a similar manner to the data presented in Table 8A, the same measurements of water solubility, surface tension and Draves wetting were made on lactide modified polysorbate 20, specifically Tween 20. As shown in Table 8B, lactide derivatives of Tween 20 with both four and eight moles of lactic acid (LA) were tested and the properties were compared to Tween 20 alone. The data indicate that the lactide modified Tween 20 exhibit lower surface tension than the Tween 20 alone, with Draves wetting times that were comparable or faster.

TABLE 8B
Physical properties of Polysorbate-20 and
Corresponding Lactide Derivatives

| | | | Draves | Surface |
|---|---|---|---|---|
| | | | Wetting | Tension |
| Active @ 0.1% | pH | Appearance | (sec) | (mN/m) |
| ECO Tween 20 | 5.7 | clear | >5 min | 37.9 |
| (polysorbate-20) | | | | |
| (LA)₈-Tween 20 | 4.0 | hazy | ~4 min. | 31.4 |
| (LA)₄-Tween 20 | 4.5 | clear | >5 min | 36 |

As was observed for the lactide modified alcohol ethoxylates, these values indicate that low levels of lactide can be added to polysorbates while maintaining their beneficial surfactant properties of low surface tension and fast wetting.

### Example 9

Table 9 shows examples of two home care formulations, particularly cleaning formulations for hard surfaces, which were made with compounds according to the invention. Both formulations were clear/transparent.

TABLE 9
Home Care/Cleaning Formulations

| | | Floor | Window |
|---|---|---|---|
| | | Cleaner | Cleaner |
| Component | Functionality | Wt. % | Wt. % |
| DI water | Diluent | 98.2 | 97.0 |
| EtOH | Solvent | 0.5 | 2.5 |
| (LA)2-Brij L6 | Detergent | 0.75 | — |
| (LA)4-Tween 20 | Detergent | — | 0.25 |
| sodium citrate | Builder | 0.3 | 0.15 |
| sodium gluconate | Chelator | 0.25 | 0.10 |
| Total | — | 100.0 | 100.0 |
| pH | — | 7.24 | 7.58 |

It is to be understood that the invention is not to be limited to the details of the above embodiments, which are described by way of example only. Many variations are possible.

1. A compound which is a polylactic acid and polyether copolymer, wherein the compound comprises:
a) at least one of: a sorbitan ester residue, a C6 to C24 fatty alcohol residue or a C6 to C24 fatty acid residue;
b) at least 2 lactic acid residues; and
c) at least 2 oxyethylene groups; and
wherein the compound comprises at least two ether bonds and at least two ester bonds.

2. The compound according to claim 1 wherein the compound comprises a sorbitan ester residue.

3. The compound according to claim 1 wherein the compound comprises a C6 to C24 fatty alcohol residue.

4. The compound according to claim 1 wherein the compound comprises a C6 to C24 fatty acid residue.

5. The compound according to claim 1 wherein the compound comprises from 2 to 18 lactic acid residues.

6. The compound according to claim 1 wherein the compound comprises from 4 to 30 oxyethylene groups.

7. A process for producing a compound wherein the process comprises reacting the following reactants:
a) at least one of: a polysorbate, a C6 to C24 fatty alcohol ethoxylate or a C6 to C24 fatty acid ethoxylate; and
b) lactide;
wherein the compound comprises at least 2 lactic acid residues at least 2 oxyethylene groups.

8. A compound obtained by a process according to claim 7.

9. The compound according to claim 8 wherein the compound comprises from 4 to 18 lactic acid residues

10. The compound according to claim 8 wherein the compound comprises from 4 to 30 oxyethylene groups.

11. Use of a compound according to claim 1 to treat a polymeric substrate by applying the compound to the substrate to produce a treated polymeric substrate.

12. Use according to claim 11 wherein the treated polymeric substrate is less hydrophobic than the polymeric substrate

13. Use according to claim 12 wherein the treated polymeric substrate being less hydrophobic is indicated by a shorter strike-through time, measured as described herein.

14. Use according to claim 11 wherein the polymeric substrate comprises, as a polymer or co-polymer, at least one of polylactic acid, polyethylene and polypropylene.

15. A method of treating a polymeric substrate comprising applying a compound according to claim 1 to the polymeric substrate.

16. The method according to claim 15 wherein the method produces a treated polymeric substrate which is less hydrophobic than the polymeric substrate.

17. A polymeric fibre which has been treated with a compound according to claim 1.

18. A nonwoven material which has been treated with a compound according to claim 1.

19. A personal hygiene product comprising a nonwoven material according to claim 18.

20. A home care formulation comprising a compound according to claim 1 and at least one additional home care ingredient.

21. A cleaning formulation comprising a compound according to claim 1.

22. Use of a compound according to claim 1 as a surfactant, preferably a non-ionic surfactant.

23. Use according to claim 22 wherein the compound is used in a cleaning formulation, preferably a low foaming cleaning formulation.

24. A method of reducing the foaming properties of a surfactant comprising the step of reacting at least two lactic acid residues onto the surfactant, preferably wherein the foaming of the surfactant is measured using ASTM D1173.

25. The method according to claim 24 wherein the surfactant is selected from a polysorbate, a C6 to C24 fatty alcohol ethoxylate or a C6 to C24 fatty acid ethoxylate.
